(19) United States
(12) Patent Application Publication
(10) Pub. No.: US 2003/0074568 A1
(43) Pub. Date: Apr. 17, 2003

(54) Methods and apparatuses for performing secure transactions without transmitting biometric information

(76) Inventors: David J. Kinsella, Austin, TX (US); Richard W. Fisk, Dripping Springs, TX (US)

Correspondence Address: Mr. David Kinsella, 117 Medalist, Austin, TX, 78734, US

(21) Appl. No.: 09/982,114

(22) Filed: Oct. 17, 2001

(51) Int. Cl. H04L 9/00

(52) U.S. Cl. 713/186

(57) ABSTRACT

Methods, systems, and devices for performing secure transactions with remote computer systems. User authentication acts independently of any remote computer system with which the person may communicate. The authenticating device itself may be registered with remote computer systems with which the user wishes to obtain access. The device need not pass any biometric information to any remote computer system. Instead, biometric authentication may be initiated and completed on the device itself. What is passed from the device to the remote computer system is device-specific information, which identifies the device to the remote computer system.

### BACKGROUND OF THE INVENTION

1. Field of the Invention

This invention is related to biometric devices, and more particularly to stand-alone biometric devices that can be registered to operate with one or more remote computer systems. Even more particularly, the invention is related to biometric devices that internally authenticate the identity of a user using biometric information; once the user is authenticated, the device is allowed to securely interface with a remote computer system. No biometric information about the user need be passed to the remote computer system because the entire biometric authentication process may be done on the device itself.

2. Description of Related Art

Presently, there are a number of systems that promise to provide secure authentication of individuals using different types of biometric information. However, these systems typically require the individual to first provide a copy of his or her biometric information to a remote computer system so that it may be used as a comparison to what he or she will later provide in order to gain access. For instance, in the context of a bank having automatic teller machines: a user may be asked to provide his or her fingerprint to the bank upon signing-up for an automatic teller card. When that person later wishes to withdraw money, a fingerprint reading may be taken at the automatic teller machine and compared with the fingerprint previously provided to the bank. If there is a match, the remote computer system (in this case, the bank and automatic teller machine) may allow the withdrawal of cash to take place.

Providing one's biometric information to a remote computer system that is out of the control of the user, however, presents a serious security concern since the biometric information is now available to the institution to which it was provided. Using the example given above, a copy of the user's fingerprint is stored by the bank and is out of the control of the user. The user must simply trust the bank not to lose the fingerprint information, sell the fingerprint information, allow the information to be stolen, or disclose the information to others.

Although most reputable institutions guarantee that any biometric information will be kept securely and will remain private, the risk of identity theft and loss of privacy is nevertheless still a possibility. This risk is especially great if the institution holding the biometric information does not have sophisticated computer systems and safeguards in place to keep biometric information secret. In fact, the risk of unauthorized disclosure of biometric information may become so great in some circumstances that the benefits afforded by biometrically authenticated transactions may be surpassed. In other words, and using the same example as above, if a bank can't keep your biometric information secret, it may not be worthwhile to give them your fingerprint in the first place—it may be more secure to simply use a Personal Identification Number (PIN) when you want to withdraw money instead of using your fingerprint.

Besides problems associated with the transmission of biometric information to remote computer systems that are out of the control of the users, typical authentication systems also suffer from shortcomings concerning the inability to easily delegate authority to others. Using the biometric banking example above, if a user wanted a friend to withdraw cash for him, that friend would not be allowed (unless the friend went to the bank and registered in the presence of the account owner, thereby giving the bank his biometric information and trusting the bank to keep that information safe). This inability to easily and quickly delegate authority is a shortcoming of traditional systems that makes it difficult for users to flexibly manage who is allowed to gain access to remote computer systems.

Due at least the shortcomings discussed above, a system that would allow for biometrically-authenticated transactions, without providing biometric information to a remote computer system, would be advantageous. Additionally, a system that allows for the easy delegation of authority (without sacrificing security) would also be advantageous.

### SUMMARY OF THE INVENTION

Embodiments of the present disclosure are aimed at addressing the following shortcomings mentioned above: (a) shortcomings associated with providing biometric information to a remote computer system over which the user has no control and (b) shortcomings associated with the inability to quickly and easily delegate biometric-related access privileges to others. As used herein, “remote computer system” simply means any type of computerized system that is remote from the device on which biometric authentication takes place.

Certain embodiments of this disclosure involve a biometric device that communicates with a remote computer system if (a) the user has been biometrically identified as the owner of the device (or one who has been delegated access privileges) and (b) the device has been registered with the remote computer system to perform certain transactions prior to the initiation of communication. The inventors have coined the phrase “biometric passkey” to describe a device having these or similar characteristics. As will be understood with the benefit of this disclosure, the biometric passkey can include any combination of hardware, software or firmware that provides a biometrically-authenticated device that can transmit information to another system or device in order to allow a user to gain access or entry.

Advantageously, the biometric passkey need not transmit biometric information to the remote computer system because the entire biometric authentication process may take place on the device itself rather than within the remote computer system. Thus, instead of sending biometric information, the biometric passkey may simply send some identifying data stream (not containing any biometric information) to the remote computer system to inform the remote computer system that the biometric passkey (a) wishes to use the remote computer system and (b) has (or has not been) authenticated by the user.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a flow diagram of embodiments of the present disclosure relating to a biometric device, coined a “biometric passkey,” that can be registered to operate with a remote computer system and that can perform secure transactions without sending any biometric information to that computer system.

FIG. 2 is another flow diagram of embodiments of the present disclosure relating to a biometric passkey.

### DESCRIPTION OF ILLUSTRATIVE EMBODIMENTS

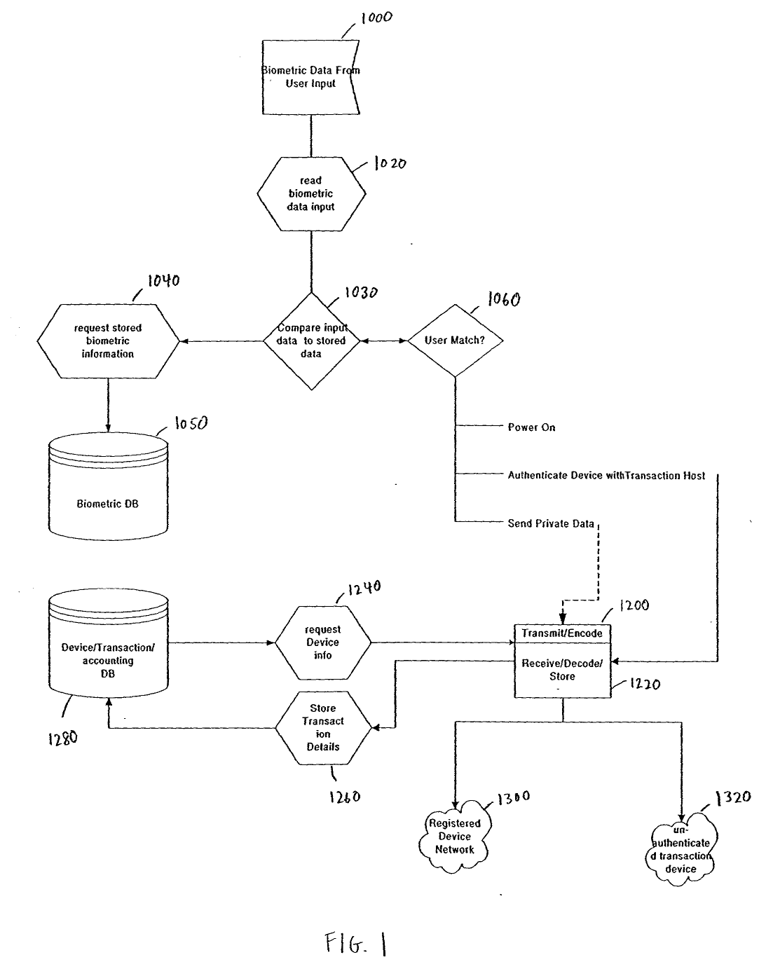

FIG. 1 illustrates embodiments in which a biometric device can be registered to operate with one or more remote computer systems and can perform biometrically-authenticated transactions without relinquishing control of the user's precious biometric information.

The upper portion of FIG. 1 illustrates a flow diagram corresponding to the operation of a biometric device (a “biometric passkey”) having at least the following advantageous characteristics: (a) it can perform secure transactions without transmitting biometric information to a remote computer system and (b) it can easily delegate authority to others. In step 1000, biometric data is input from a user. This input of biometric data can involve any one or more of biometric identification methods known in the art. For instance, this step may represent the taking of a fingerprint. Alternatively, it may represent the scanning of a retina, the recognition of a voice, the recognition of DNA, the taking of a thumb or toe-print, the taking of a handwriting sample, or the like. In general, any methodology known in the art for obtaining unique biometric information from the user will suffice.

In step 1020, the biometric data is read by the biometric passkey. This step may also involve any biometric methodology known in the art. For instance, if the biometric data includes a fingerprint, step 1020 may involve reading that fingerprint using one or more sensors and, if necessary, appropriate software. Likewise, if the biometric data includes a recorded voice sample, step 1020 may involve software appropriate for characterizing that voice sample. In general, any methodology known in the art for reading and interpreting biometric information from a user will suffice.

In steps 1030, 1040, 1050, and 1060, the biometric information of the user is verified within (or in operative relation to) the biometric passkey. In particular, the biometric data read in step 1020 is compared in step 1030 with stored biometric data accessible by the biometric passkey. The stored biometric data necessary for this comparison is retrieved via step 1040 from biometric database 1050. This database is analogous to the user storage 226 described in U.S. Pat. No. 6,148,094, which is incorporated herein by reference. The database allows for the comparison of stored biometric information with biometric information being provided by a user who is attempting to complete some type of secure transaction.

Because the biometric database 1050 is separate from the remote computer system represented by the lower portion of FIG. 1, it is not necessary for the user to give any of his or her biometric information to the remote computer system. Rather, all the biometric information necessary for the user-authentication process may be stored in database 1050, which may be integral with (or in operative relation to) the biometric passkey. This provides for added security because the user is always in control of his or her biometric information. In other words, in this embodiment the biometric information need never be in the hands of the remote computer system—it can remain with the biometric passkey instead.

Besides having the database 1050, the biometric passkey may also utilize an authorization profile storage and audit log storage, both of which are described in U.S. Pat. No. 6,148,094, which has been incorporated by reference. In particular, the authorization profile storage may store information such as permissible dates, times, functions, transactions, and remote computer systems allowed for each user who may use the biometric passkey. The audit log storage may be used to store successful and unsuccessful accesses to the biometric passkey and/or remote computer systems. Additionally, the audit log storage may store transaction information for users who successfully or unsuccessfully gained access to the biometric passkey and/or remote computer systems. For unsuccessful transaction attempts, the audit log storage may store biometric and transaction information associated with the attempted transaction. This information may be used later to identify culprits who were attempting to use the biometric passkey (or gain access to a remote computer system) without proper authorization.

The authorization profile storage and audit log storage may be implemented together as one or more digital memory devices, or may be implemented using separate memory technologies, such as writable CD ROM, magnetic disk, optical disk, flash memory, and other well known technologies. In one embodiment, the authorization profile storage and audit log storage may be part of the biometric database illustrated in FIG. 1 as element 1050. The authorization profile storage and the audit log storage may store encoded information and may also be implemented as an electronic memory device connected to the biometric passkey, such as a removable memory device. This affords, for example, an authorized user to carry his profile in a removable device.

The hardware and software of the biometric passkey subject of FIG. 1 may be of any type so that stand-alone biometric authentication may take place. The physical manifestations of the biometric passkey are vast and may include, but are not limited to: (a) a pointing device such as a mouse, trackball or graphics tablet, (b) a personal computing device such as a PALM PILOT (or any other personal digital assistant (PDA) or handheld computing device) or a laptop or desktop computer, (c) a portable telephone, (d) a pager or remote e-mail device, or (e) any other electronic device that can be used to interface with one or more other systems. The software associated with the biometric passkey may be of any type that at least allows the device to authenticate a user's biometric information. For instance, commercially available software that compares fingerprint information may be used.

The type of authentication used within the biometric passkey may be of any type described herein, including continuous authentication (i.e., the authentication takes place continuously as the user is using the device), semi-continuous authentication (i.e., the authentication takes place at discreet time intervals), transaction-based authentication (i.e., the authentication takes place whenever the user attempts to perform a transaction—for instance, every time the user clicks a button of the device), one-shot authentication (i.e., the authentication takes place when the user first uses the device), or any combination thereof.

In certain embodiments, the biometric passkey may be operated even if the user has not been authenticated using biometric information. In such embodiments, the unauthenticated biometric passkey may be used like any other non-biometric personal electronic device. For instance, in a non-limiting example, non-authenticated users may be allowed to use a calculator feature of a personal digital assistant but not the email features. More generally, non-authenticated users may be allowed to use certain low-security features of the biometric passkey while authentication would be required for more sensitive features.

Additionally, non-authenticated users may be allowed to interface with certain remote computer systems to engage in transactions that need not be secure. For instance, in a non-limiting example, a non-authenticated biometric passkey may be able to access a remote computer system that provides time, date, and temperature information but not a remote computer system that allows for the withdrawal of cash. Non-authenticated access is shown in FIG. 1 as element 1320, which represents transactions that can be performed by a biometric passkey with a non-authenticated user.

Generally speaking, there are at least two ways in which a user-authenticated biometric passkey (i.e., a biometric passkey that is being used by a user who has been authenticated using biometric information) may interact with the remote computer system shown in FIG. 1. In a first embodiment, the biometric passkey is registered to operate with the remote computer system. In a second embodiment, the biometric passkey is not registered to operate with the computer system.

In the first embodiment, registering with the remote computer system may involve storing device-specific information (rather than user-specific biometric information) with the remote computer system prior to, or concurrent with, a transaction. When the biometric passkey wishes to transact with the remote computer system, the biometric passkey will send device-specific information to the remote computer system. The remote computer system will determine if that device-specific information matches information in a corresponding registration list or database. If a match occurs, the remote computer system will know that the biometric passkey is authorized to make a secure transaction (i.e., the biometric passkey is authenticated for use with the remote computer system). If this case, the biometric passkey is given access to a registered device network, illustrated in FIG. 1 as 1300. Element 1300 represents transactions that can be performed by an authenticated biometric passkey.. If a match does not occur, the biometric passkey may be given an option to register with the remote computer system, it may be denied access, or it may be allowed to access element 1320, which represents transactions that can be performed by a biometric passkey with a non-authenticated user.

In the second embodiment, registration of the biometric passkey may not be needed. In such an embodiment, the user-authenticated biometric passkey may simply be allowed to interface with the remote computer system to perform one or more low-security transactions despite not being registered. The remote computer system may, nevertheless, request device-specific information from the user-authenticated biometric passkey prior to performing the low-security transactions. Upon receipt of this information, the remote computer system may allow the biometric passkey to access element 1300 of FIG. 1. Alternatively, the remote computer system may allow the non-registered biometric passkey to only access element 1320 of FIG. 1 regardless of whether any device-specific information was transmitted.

Between the upper and lower portions of FIG. 1, three different functions are shown: power on, authenticate device with transaction host, and send private data. The power on function simply illustrates that the biometric passkey may be turned on so that it may communicate with the remote computer system illustrated in the lower portion of FIG. 1. Once turned-on, the biometric passkey may authenticate the user using any known authentication technique (e.g., continuous authentication, semi-continuous authentication, transaction-based authentication, one-shot authentication, or any combination thereof). Once turned-on, the biometric passkey may be used to interface with the remote computer system by any methods known in the art. For instance, if the biometric passkey is a pointing device, interfacing with the remote computer system may involve using the pointing to device to point to, and select, one or more transactions from the remote computer system. Alternatively, if the biometric passkey is a personal digital assistant, interfacing with the remote computer system may involve using a modem or other communication link to pass data to the remote computer system.

The “authenticate device with transaction host” and “send private data” functions may be explained in conjunction with the elements illustrated in the lower portion of FIG. 1. Once a biometric passkey begins interfacing with a remote computer system, that system may request device information (rather than biometric information) from the biometric passkey in order to authenticate the biometric passkey itself. This request is represented by step 1240 of FIG. 1,

In response to request 1240, the biometric passkey may identify itself to the remote computer system (represented by the “authenticate device with transaction host” step) by sending non-biometric, device-specific data to the remote computer system. This device-specific information, which may be encoded and then decoded by the remote computer system as illustrated in step 1220, may be compared to device-specific registration information stored in database 1280. If a match occurs, the biometric passkey is confirmed as being registered (hence, authenticated) and can correspondingly access element 1300 to perform secure transactions. In this embodiment, database 1280 is analogous to database 1050, described earlier in this disclosure.

This registration-confirming step (passkey authentication) should not be confused with the authentication of the user himself (user-authentication). The authentication of the user is a separate step that involves the comparison of biometric information by the biometric passkey; the registration-confirming process, on the other hand, involves the comparison of non-biometric, device-specific information. Keeping these two types of authentication processes separate allows the user to perform secure transactions without transmitting biometric information to remote computer systems.

As discussed earlier, registration of the biometric passkey may not be needed. In such an embodiment, the remote computer system may, nevertheless, request device-specific information from the authenticated biometric passkey in step 1240 prior to performing certain transactions. This information may be stored in database 1280 or 1260 in conjunction with an audit log, discussed below. Upon receipt of this information, the remote computer system may allow the biometric passkey to access element 1300 of FIG. 1. Alternatively, the remote computer system may allow the non-authenticated biometric passkey to only access element 1320 of FIG. 1.

Once a biometric passkey has gained access to the remote computer system (as a user-authenticated, registered device; as a user-unauthenticated, registered device; as a user-authenticated, unregistered device; or as a user-unauthenticated, unregistered device), the biometric passkey may send private data to the remote computer system to effect a particular transaction. This step is illustrated as the “send private data” step in FIG. 1. As illustrated, the data may be encoded in step 1200 to increase its privacy, although such encoding is optional.

Besides having the database 1280, the remote computer system may also utilize an authorization profile storage and an audit log storage. In particular, the authorization profile storage may store information such as permissible dates, times, functions, transactions, and remote computer systems allowed for each biometric passkey. The audit log storage may be used to store successful and unsuccessful accesses to the remote computer systems by particular biometric passkeys. Additionally, the audit log storage may store transaction information for biometric passkeys that successfully or unsuccessfully gained access to the remote computer systems. For unsuccessful transaction attempts, the audit log storage may store device and transaction information associated with the attempted transaction. This information may be used later to identify the biometric passkey that was attempting to make a transaction without proper authorization.

As before, the authorization profile storage and audit log storage may be implemented together as one or more digital memory devices, or may be implemented using separate memory technologies, such as writable CD ROM, magnetic disk, optical disk, flash memory, and other well known technologies. In one embodiment, the authorization profile storage and audit log storage may be part of database 1280 illustrated in FIG. 1. The authorization profile storage and the audit log storage may store encoded information and may also be implemented as an electronic memory device connected to the remote computer system, such as a removable memory device.

The device-specific information sent by the biometric passkey to the remote computer system may be any type of information that is unique to the passkey itself. In one embodiment, the device-specific information may involve a fixed string of alphanumeric characters that identify the passkey device. In another embodiment, the device-specific information may involve a fixed binary code. In other embodiments, the device-specific information may be dynamic and may convey certain information about the biometric passkey. For example, the device-specific information may include a fixed string of information followed by one or more flags that indicate a particular state of the biometric passkey.

In one embodiment, a flag may indicate whether the biometric passkey has been properly authenticated by its user. For instance, if I were the authorized user of a biometric passkey, and I had my fingerprint authenticated by the passkey, a flag in the device-specific information may be set to a 1. In this example, the 1 would indicate to a remote computer system that my biometric passkey was user-authenticated (it was being operated by a person who had been properly authenticated by the biometric passkey). In contrast, if an unauthorized user were using my biometric passkey, they would fail a fingerprint test and the flag could be set to 0. In that case, the remote computer system would know that the biometric passkey was not user-authenticated (hence, it could be operated by someone who had not been properly authenticated by the biometric passkey). In this circumstance, the remote computer system may disallow access to all transactions (or a subset of transactions). On the other hand, if the type of transaction being requested required no or low security, the remote computer system may allow access even from an unauthenticated user, as described above.

In other embodiments, different flags may be used to indicate a myriad of different information about the biometric passkey and/or its user. For example, a flag may indicate whether the user of the biometric passkey is over or under the age of 21. In particular, the biometric passkey may store not only biometric information for each authorized user but also information about those user's age, sex, address, or any other type of information.

As a non-limiting example, a flag may be set as 1 if the user is over 21 and as a 0 if he or she is under 21. This embodiment would allow a remote computer system to allow or disallow access based on age (for instance, if the user was requesting to purchase alcohol). In another embodiment, a remote computer system may know, based on a flag, whether or not to charge sales tax for an item based on an address. In this case, the flag may be a number from 1-50, representing the state of residency of the user.

In another embodiment, the biometric passkey may be equipped with one or more substance detection sensors as described in this disclosure. With such sensors, a flag may be set to indicate whether the user is intoxicated. For instance, a 1 may indicate a sober user while a 0 may indicate an intoxicated user. A remote computer system may then base access decisions on this flag. For example, a remote computer system may refuse to allow a biometric passkey to withdraw money if the flag were 0, while it may allow the passkey to check a bank account balance.

The hardware and software of the remote computer system that is the subject of this example may be of any type sufficient to allow interfacing with the biometric passkey. The physical manifestations of the remote computer system can be extremely vast and can include, but are not limited to: (a) automatic teller machines and financial institutions, (b) retail computer systems allowing for the purchase of goods, (c) real estate systems, (d) online computer systems, (e) airline computer systems, (f) automobile computer systems, and (g) any other computerized system that provides for one or more transactions.

The software associated with the remote computer system may be of any type that allows the biometric passkey to communicate with the system and allow for one or more transactions to take place. For instance, commercially available software that processes sales information may be used in embodiments involves retail computer systems.

The techniques illustrated in FIG. 1 allow not only for secure transactions to be made without transmitting biometric information, but they also allow users to quickly and easily delegate authority to one or more people who wish to perform transactions with the biometric passkey. Because the biometric data resides on (or in operative relation to) the biometric passkey and not the remote computer system, users of this device may delegate authority simply by adding the biometric information of one or more delegated persons to the biometric passkey. For instance, if I wanted my brother to be able to use my personal digital assistant, I could enter his fingerprint information into database 1050. When he used the device, he would be authenticated and could perform secure transactions with remote computer systems as outlined above.

Using the authorization profile storage, one can set up allowed transaction parameters for each delegated user. For example, and using the example above, I could set up an authorization profile storage for my brother so that he would be allowed to perform any financial transaction using my biometric passkey except for the withdrawal of money. If he tried to withdraw money, the authorization profile storage would note that the transaction is not allowed and would deny access to the remote computer system by not passing the withdrawal request to the remote computer system. Additionally, if equipped with an audit log storage, the biometric passkey may make an entry consisting of my brother's fingerprint, the transaction he attempted (i.e., how much money did he try to withdraw), and the date and time of that attempted transaction. Additional information may be added to the audit log storage as will be understood with the benefit of the present disclosure.

Due to the flexibility of the authorization profile storage and the ease of delegating different users by entering their biometric data into database 1050, the device of FIG. 1 is extremely powerful. In particular, it allows users to easily and quickly set up different user profiles for several different people to use a single biometric passkey to perform secure transactions. This ability does not compromise any of the user's biometric data because it is not transmitted to the remote computer system. Rather, it is device-specific information about the biometric passkey itself (and one or more flags that do not reveal biometric information) that is transmitted. The biometric data remains safe within (or in operative relation with) the biometric passkey, in the control of the one or more users.

The applications for the techniques illustrated in FIG. 1 are vast and will be readily understood by those having skill in the art with the benefit of this disclosure. In one non-limiting embodiment, the techniques of FIG. 1 may be used to allow two or more people to complete a financial transaction although they may be miles apart. For example, a remote computer system for handling retail transactions may secure the sale of an item. An authenticated, registered seller of the item may transmit pertinent information to the remote computer system from location A. An authenticated, registered buyer may transmit pertinent information to the remote computer system from location B to complete the sale. These transmissions may occur simultaneously or at different times. Because of the advantages of the techniques described herein, neither the buyer nor the seller has entrusted his or her biometric information to the remote computer system. Nevertheless, the remote computer system is assured that the user's are who they say they are because they have used a biometric passkey that has been user-authenticated and device-authenticated with the remote computer system.

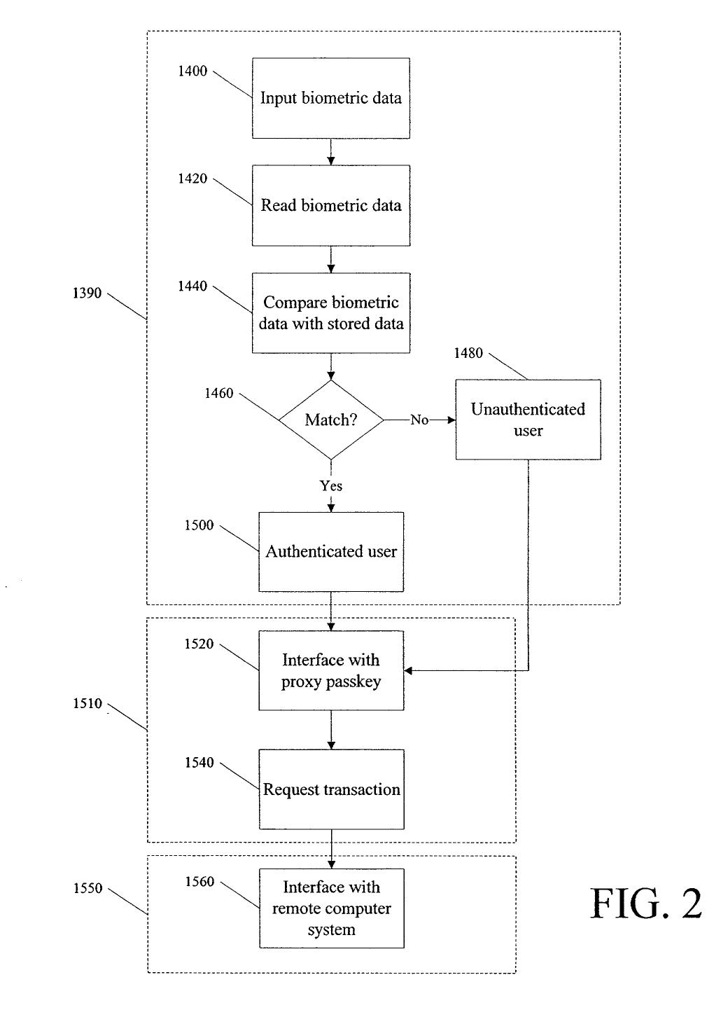

FIG. 2 shows another embodiment using the concept of a biometric passkey. In this embodiment, two passkeys are used to complete a transaction, with one of the passkeys acting as a proxy.

Illustrated in FIG. 2 are: an initiating passkey 1390, a proxy passkey 1510, and a remote computer system 1550. In step 1400, biometric data is input into the initiating passkey. In step 1420, the biometric data is compared against stored data to determine if the user is authentic (or if the user has delegated privileges). In step 1460, the match is determined. If a match occurs (indicating an authenticated or delegated user), the user is authenticated as illustrated by box 1500. If, on the other hand, a match does not occur, the user is not authenticated as shown by box 1480.

After the user-authentication process, the initiating passkey interfaces with another passkey, the proxy passkey 1510. The interfacing step is shown as 1520 and may include any type of interfacing known in the art such as, but not limited to, dial-in communication over a modem or over the internet. In step 1540, the initiating and/or proxy passkey requests a transaction from the remote computer system 1550.

In step 1560, the proxy passkey 1510 interfaces with the remote computer system 1550 to conclude the transaction.

The methodology of FIG. 2 is useful for a host of different applications, as will be understood by one having ordinary skill in the art. For instance, in one non-limiting example, FIG. 2 may be used to effect a credit card, debit-cart, smart-card, or electronic cash transaction. In that example, the initiating passkey 1390 represents the passkey of the buyer, the proxy passkey 1510 represents the passkey of the seller, and the remote computer system 1550 represents the appropriate computer system of the financial institution (such as a credit card company).

In this example, the buyer may see an item he wishes to purchase at a kiosk in the mall. He picks up his passkey 1390 and places his finger on a fingerprint sensor of the passkey 1390 to input his biometric data (step 1400). The passkey 1390 reads his fingerprint (step 1420) and compares it against data stored within the passkey to determine if the user is the owner of the passkey or if he is a person delegated to use it (step 1440). Because passkey 1390 may be equipped with a authorization profile, passkey 1390 may also check if the user is allowed to even use the passkey on this date, at this particular time, etc. The passkey 1390 may also check the user's age, sobriety, etc. to determine if he is allowed to continue. Passkey 1390 may include an audit log storage to keep track of both unsuccessful and successful transaction information, including fingerprint information associated with each transaction attempt.

In step 1460, the passkey completes its determination of whether the user is authentic. For the sake of this example, let's assume that the user is someone who's biometric data matches data in storage, and that user is allowed to proceed with any transaction he chooses (step 1500).

The user approaches the kiosk owner and informs him that he wishes to purchase the item. The kiosk owner then places his own passkey (the proxy passkey 1510) onto the table. The user, with his finger still over the fingerprint sensor (which assumes, for this example, that the mode of verification is continuous), transmits his credit card information (or any other type of payment information including electronic cash information or smart-card information) along with device-specific information about passkey 1390 to the proxy passkey 1510 (step 1520). Advantageously, no biometric information is transferred to the kiosk during this step. This transfer process may be via an infrared communication link or by any other means known in the art suitable to link the two passkeys.

The proxy passkey 1510 may then check the device-specific information (which may contain a flag indicating that the user has been authenticated) against stored data to see if passkey 1390 has pre-registered with the kiosk. If a match is found, the kiosk may a continue with the transaction, knowing that this is a registered (and a user-authenticated) passkey. If a match is not found, the kiosk owner may ask the user for additional information such as his address, telephone number, etc. Alternatively, the kiosk may continue with the transaction regardless of whether a device-match is made or not, as long as the device-specific information indicates that the user has been authenticated (in other words, the user is who he says he is, and he is authenticated to proceed).

The proxy passkey 1510may include an authorization profile and/or an audit log storage. The authorization profile may be used to ensure that certain types of transactions do not take place. For instance, the authorization profile may not allow a store clerk to transact for a purchase over $1000 before first calling the manager. The audit log storage, on the other hand, may keep track of both successful and unsuccessful transaction attempts including keeping track of the device-specific information from passkey 1390, which is making those attempts.

In one embodiment, proxy passkey 1510 may include a credit card/debit card reader or any other hardware peripheral that can, for example, swipe the magnetic tape of credit cards to obtain account information to accommodate users who do not happen to have a biometric passkey.

For the sake of this example, let's assume that the user is authenticated, passkey 1390 is pre-registered with the kiosk, and the kiosk's passkey 1510 is allowed to proceed. In this case, the proxy passkey 1510 then opens a communication link with the remote computer system 1550, which may be preceded by the authentication of the user of the proxy passkey (the kiosk operator) via his biometric information. The remote computer system of this example is the appropriate financial (e.g., credit card) computer system. The proxy passkey 1510 requests to log a transaction in the amount of the purchase price (step 1540) with the remote computer system 1550.

In this step, proxy passkey 1510 may transmit device-specific information about the proxy passkey 1510 and/or about the user's passkey 1390. For example, the proxy passkey 1510 may transmit information telling the remote computer system that unique proxy passkey 1510 from a particular kiosk in a particular mall wishes to log a transaction in a particular amount. The remote computer 1550 may determine that the device-specific information from the proxy passkey 1510 matches an entry in its database and may continue with the transaction.

The remote computer system may include an authorization profile and an audit log storage. It may use its authorization profile to determine if the requested transaction is allowed. It may use the audit log to record the details of the transaction, be it successful or unsuccessful.

Alternatively, or additionally, the proxy passkey 1510 may transmit the device-specific information from the initiating passkey 1390 to the remote computer system 1550. In this case, the remote computer system 1550 may determine if a match occurs before continuing with the transaction or it may simply log the device-specific information for record-keeping and allow the transaction to proceed. In step 1510, the proxy passkey completes the transaction by logging the details of the transaction (step 1560), and the sale is completed.

In this example, a secure purchase is conducted using biometric information that is never transmitted to remote systems. Credit card information is used without the need for extra verification or signatures. Additionally, the proxy passkey 1510 is able to accept a credit card transaction without having to employ card-swiping hardware (although it may alternatively include such hardware). The methodology of FIG. 2 therefore makes it easier for any business to be able to accept credit cards (or electronic cash) in a secure manner.

In general, the concept of a proxy passkey device allows, among other things, any pre-registered passkey to initiate transactions for other, unregistered passkeys. In the example above, device-specific information from the kiosk's passkey is registered with a remote, credit-card computer system. This, in turn, allows other passkeys to initiate a transaction with the credit card computer's system by going through the proxy. This concept, especially in combination with the authorization profile and audit log features discussed in this disclosure, provides great versatility. For example, if I have a passkey registered with a remote computer system, I may act as a proxy. Further, if my passkey includes a user authorization profile and audit log storage, I can deny specific transactions based on permissible dates, times, functions, transactions, and remote computer systems. And, using an audit log storage I can keep track of all aspects of successful and unsuccessful transaction attempts.

As an example, if I were the head of household, I could allow members of my own family to either withdraw cash or transmit cash (or other information) based on the registration of their devices in my own pass key's registration database. I could also allow or deny transactions based on preset criteria such as credit limit or any other arbitrary information.

In addition I could, rather than delegate authority to a biometrically authenticated user of my own device, “delegate” certain transactions that would accept a transaction from a family member who has his own personal passkey, yet my device initiates and authenticates the transaction with the remote computer system once I have authenticated myself to the device using biometrics, thus completing the transaction as if I had initialized it.

All of the apparatuses and methods disclosed and claimed herein can be made and executed without undue experimentation in light of the present disclosure. While techniques of this invention have been described in terms of specific embodiments, it will be apparent to those of skill in the art that variations may be applied without departing from the concept, spirit and scope of the invention. All such variations apparent to those skilled in the art are deemed to be within the spirit, scope and concept of the invention as defined by the appended claims.

What is claimed is:

1. A biometric passkey device configured to perform one or more transactions with a remote computer system without transmitting any biometric information to that remote computer system, the passkey device being configured to:
(a) authenticate the identity of a user by comparing the user's unique biometric information with biometric information stored with the passkey device;
(b) transmit unique passkey device information to the remote computer system to authenticate the identity of the passkey device; and
(c) perform one or more transactions with the remote computer system if the identity of the user is first authenticated by the passkey device and the identity of the passkey device is next authenticated by the remote computer system.

2. The device of claim 1, wherein the device further comprises an authorization profile storage.

3. The device of claim 1, wherein the device further comprises an audit log storage.

4. The device of claim 1, wherein the device further comprises a substance detection sensor.

5. The device of claim 4, wherein the substance detection sensor detects blood alcohol content of the user.

6. The device of claim 1, wherein the unique passkey device information comprises a flag indicating the state of the passkey device.

7. The device of claim 6, wherein the flag indicates whether the device has authenticated the identity of the user.

8. The device of claim 6, wherein the flag indicates the age of the user.

9. The device of claim 1, wherein the device comprises a pointing device.

10. The device of claim 1, wherein the device comprises a personal digital assistant.

11. A system for performing secure transactions between a biometric passkey device and a remote computer system without transmitting any biometric information to that remote computer system, the system comprising:
(a) a biometric passkey device configured to (i) authenticate the identity of a user by comparing the user's unique biometric information with biometric information stored with the passkey device; and (ii) transmit unique passkey device information to the remote computer system; and
(b) a remote computer system configured to (i) authenticate the identity of the passkey device by comparing the unique passkey device information with device information stored on the remote computer system; and (ii) allow the passkey device to perform one or more transactions on the remote computer system if the identity of the user is first authenticated by the passkey device and the identity of the passkey device is next authenticated by the remote computer system.

12. The system of claim 11, wherein the passkey device comprises a proxy passkey.

13. The system of claim 11, wherein the passkey device further comprises an authorization profile storage.

14. The system of claim 11, wherein the passkey device further comprises an audit log storage.

15. The system of claim 11, wherein the passkey device further comprises a substance detection sensor.

16. The system of claim 11, wherein the unique passkey device information comprises a flag indicating the state of the passkey device.

17. The system of claim 11, wherein the passkey device comprises a pointing device.

18. The system of claim 11, wherein the passkey device comprises a personal digital assistant.

19. The system of claim 11, wherein the remote computer system comprises retail computer system configured to allow users to make purchases.

20. A method for performing secure transactions between a biometric passkey device and a remote computer system without transmitting any biometric information to that remote computer system, the method comprising:
(a) authenticating the identity of a user by comparing the user's unique biometric information with biometric information stored with the passkey device;
(b) transmitting unique passkey device information to the remote computer system;
(c) authenticating the identity of the passkey device by comparing the unique passkey device information with device information stored on the remote computer system; and
(d) performing one or more transactions on the remote computer system if the identity of the user is first authenticated by the passkey device and the identity of the passkey device is next authenticated by the remote computer system.

21. The method of claim 20, wherein the passkey device comprises a proxy passkey.

22. The method of claim 20, wherein the passkey device comprises an authorization profile storage.

23. The method of claim 20, wherein the passkey device comprises an audit log storage.

24. The method of claim 20, wherein the passkey device comprises a substance detection sensor.

25. The method of claim 20, wherein the unique passkey device information comprises a flag indicating the state of the passkey device.

26. The method of claim 20, wherein the passkey device comprises a pointing device.

27. The method of claim 20, wherein the passkey device comprises a personal digital assistant.

28. The method of claim 20, wherein the remote computer system comprises retail computer system configured to allow users to make purchases.
